(19) United States
(12) Patent Application Publication
(10) Pub. No.: US 2021/0170690 A1
(43) Pub. Date: Jun. 10, 2021

(54) SYSTEM AND METHOD FOR EMBEDDING SECURITY IDENTIFIERS IN ADDITIVE MANUFACTURED PARTS

(71) Applicant: NEW YORK UNIVERSITY, New York, NY (US)

(72) Inventors: Nikhil Gupta, Ossining, NY (US); Fei Chen, Brooklyn, NY (US)

(21) Appl. No.: 16/772,844

(22) PCT Filed: Dec. 14, 2018
(86) PCT No.: PCT/US18/65635

§ 371 Date: Jun. 15, 2020

Related U.S. Application Data
(60) Provisional application No. 62/599,285, filed on Dec. 15, 2017.

(51) Int. Cl. B29C 64/386; B33Y 10/00; B33Y 50/00; B33Y 80/00; G06K 19/06

(52) U.S. Cl. CPC B29C 64/386; B33Y 10/00; G06K 19/06028; B33Y 80/00; G06K 19/06037; B33Y 50/00

(57) ABSTRACT

A method of embedding an identifying feature into an additively-manufactured part comprises the steps of splitting an image of an identifying feature into a plurality of segments, generating a CAD model of the identifying feature with each of the plurality of segments positioned in a different layer of the CAD model, incorporating the CAD model of the identifying feature into a CAD model of an additively-manufactured part, and printing an additively-manufactured part containing a three-dimensional representation of the identifying feature, using the CAD model of the additively-manufactured part. A method of authenticating an additively manufactured part, a product made using the method of embedding the identifying feature into the additively manufactured part, and a product containing an identifying feature are also described.

### CROSS-REFERENCE TO RELATED APPLICATIONS

This application claims priority to U.S. Provisional patent Application No. 62/599,285, filed on Dec. 15, 2017, incorporated herein by reference in its entirety.

### BACKGROUND OF THE INVENTION

Additive manufacturing (AM) is one of the fastest growth sectors in R&D and industrial manufacturing, and the trend is expected to continue in the near future. Among the most common forms of additive manufacturing are the various techniques that fall under the umbrella of “3D Printing”, including but not limited to stereolithography (SLA), digital light processing (DLP), fused deposition modelling (FDM), selective laser sintering (SLS), selective laser melting (SLM), electronic beam melting (EBM), and laminated object manufacturing (LOM). These methods variously “build” a three-dimensional physical model of a part, one layer at a time, providing significant efficiencies in rapid prototyping and small-batch manufacturing. AM also makes possible the manufacture of parts with features that conventional subtractive manufacturing techniques (for example CNC milling) are unable to create.

The AM process chain relies heavily on cloud-based resources and software programs that are connected to the Internet, and so cybersecurity is a growing concern. While network security is important and is the responsibility of information technology departments of corporations, a second line of defense is necessary to protect against the theft of Computer-Aided Design (CAD) files. Whereas conventionally manufactured parts typically rely on expensive equipment (CNC machines, lathes) or physical assets (molds) to reproduce, stolen CAD files can be used to print components relatively cheaply, in quality exactly the same as the original components.

Thus, there is a need in the art for a system and method for securing products made using AM processes in order to distinguish genuine products from illicit copies. The present invention satisfies this need.

### SUMMARY OF THE INVENTION

In one aspect, a method of embedding an identifying feature into an additively-manufactured part, comprises the steps of splitting an image of an identifying feature into a plurality of segments, generating a CAD model of the identifying feature with each of the plurality of segments positioned in a different layer of the CAD model, incorporating the CAD model of the identifying feature into a CAD model of an additively-manufactured part, and printing an additively-manufactured part containing a three-dimensional representation of the identifying feature, using the CAD model of the additively-manufactured part.

In one embodiment, the identifying feature is a QR code. In one embodiment, the identifying feature is a linear barcode. In one embodiment, the entirety of the identifying feature fits within a region of the additively-manufactured part having a size no larger than 5 mm×5 mm×5 mm. In one embodiment, the entirety of the identifying feature fits within a region of the additively-manufactured part having a size no larger than 1 mm×1 mm×1 mm. In one embodiment, the additively-manufactured part comprises a photopolymer. In one embodiment, the additively-manufactured part comprises aluminum. In one embodiment, the identifying feature comprises a plurality of black elements and a plurality of white elements. In one embodiment, the regions of the three-dimensional representation of the identifying feature corresponding to the black elements are filled with material, and the regions corresponding to the white elements are empty. In one embodiment, the regions of the three-dimensional representation of the identifying feature corresponding to the black elements are filled with a first material, and the regions corresponding to the white elements are filled with a second material. In another aspect, a method of authenticating an additively manufactured part comprises the steps of obtaining a series of internal images of an additively manufactured part, selecting a subset of the series of internal images that constitute a region in which the identifying feature is embedded, scaling and rectifying the subset of the series of internal images to form a two-dimensional representation of the identifying feature, producing a processed image of the embedded identifying feature, by performing a set of image processing steps on the two-dimensional representation having a plurality of pixels at different greyscale intensities, comprising increasing the contrast of the two-dimensional representation, calculating a threshold value based on the greyscale intensities, assigning each pixel with a value above the threshold to be white, and assigning each pixel with a value below the threshold to be black, calculating a discrepancy between the thresholded two-dimensional representation of the identifying feature an original image of the identifying feature, and if the discrepancy is less than a threshold value, authenticating the additively manufactured part.

In one embodiment, the identifying feature is a QR code having at least one position identifying feature. In one embodiment, the set of image processing steps further comprises the steps of detecting contours within the two-dimensional representation, determining position and orientation of the at least one position identifying features based on the contours, generating a grid having a plurality of cells within the two-dimensional representation based on the position and orientation of the at least one position identifying features, and assigning each grid cell a value of black or white based on the values of the pixels within the grid cell.

In one embodiment, the identifying feature is a linear barcode. In one embodiment, the identifying feature is divided into a plurality of segments, each of the plurality of segments printed into a different layer of the additively manufactured part, and the method further comprises the step of combining a set of images taken at different layers of the additively manufactured part to form a single two-dimensional representation of the identifying feature. In one embodiment, the series of internal images is obtained via a CT scan. In one embodiment, the additively manufactured part is substantially transparent and the series of internal images are obtained via digital imaging. In one embodiment, the contrast is increased using multiple iterations of a contrast limited adaptive histogram equalization (CLAHE) algorithm. In one embodiment, at least five iterations of the CLAHE algorithm are performed. In one embodiment, the series of internal images is obtained via an ultrasonic scan.

In another aspect, a product made from a process of the invention is created by an additive manufacturing process, and contains a region beneath the surface of the part comprising a three-dimensional representation of an identifying feature. In one embodiment, the identifying feature is a QR code. In one embodiment, the three-dimensional representation of the identifying feature comprises a plurality of cavities.

In another aspect, a product printed using an additive manufacturing process comprises a three-dimensional representation of a QR code positioned wholly within the product, beneath the surface of the product. In one embodiment, the product comprises ABS. In one embodiment, the product comprises titanium.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of an exemplary additive manufacturing method of the present invention.

FIG. 2 is a set of 3D models and a photograph of an exemplary 3D printed QR code of the present invention.

FIG. 3A is a diagram of a tensile bar with an embedded QR code of the present invention.

FIG. 3B is an isometric view of an embedded QR code of the present invention.

FIG. 3C is a top view of an embedded QR code of the present invention.

FIG. 4A is a photograph of a 3D printed QR code.

FIG. 4B is a photograph of a 3D printed QR code.

FIG. 5A is a photograph of a sub-surface 3D printed QR code.

FIG. 5B is a photograph of a sub-surface 3D printed QR code during printing.

FIG. 6A and FIG. 6B are exemplary QR codes.

FIG. 7 is a processed image of an embedded QR code generated from a CT scan.

FIG. 8A is a CAD model of a segmented QR code.

FIG. 8B is a processed image of an embedded, segmented QR code assembled from a CT scan.

FIG. 9A and FIG. 9B are partial CT scans of two different layers of the same segmented QR code.

FIG. 10A is an exemplary linear barcode.

FIG. 10B is a CAD model of an embedded linear barcode.

FIG. 10C is a CAD model of a segmented, embedded linear barcode.

FIG. 11 is a series of photographs of different 3D printed embedded linear barcodes.

FIG. 12 is a series of photographs of different 3D printed embedded segmented linear barcodes.

FIG. 13A and FIG. 13B are exemplary processed images of embedded QR codes before and after thresholding.

FIG. 14 is an exemplary embedded QR code image before and after processing, with accompanying histograms.

FIG. 15A and FIG. 15B are an exemplary processed QR code image with a threshold applied, and with contour detection.

FIG. 16A and FIG. 16B are an exemplary processed QR code image compared to the original QR code.

FIG. 17 is a graph of discrepancy measured between two images at different grid sizes.

FIG. 18 is an exemplary tensile test bar with an embedded QR code.

FIG. 19 is a diagram of an exemplary method of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor. Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G or 4G/LTE networks, Bluetooth®, Bluetooth® Low Energy (BLE) or Zigbee® communication links, or any other method by which one electronic device is capable of communicating with another. In some embodiments, elements of the networked portion of the invention may be implemented over a virtual Private Network (VPN).

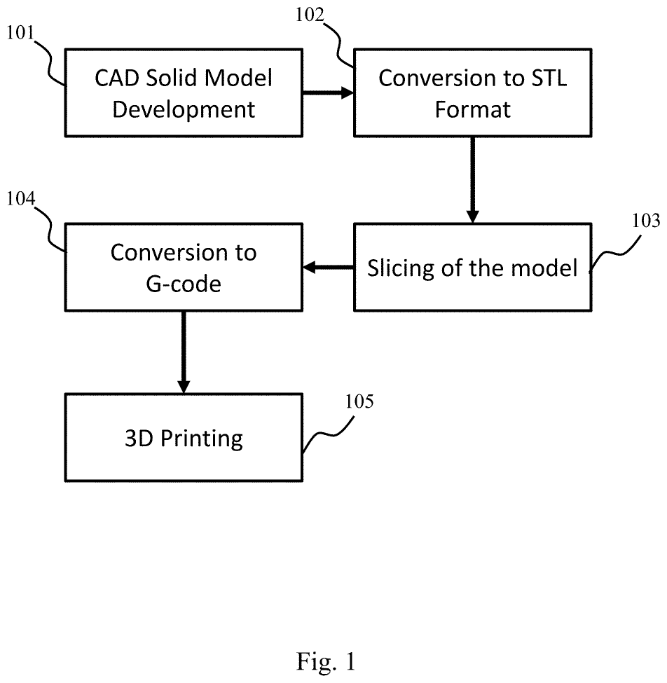

Additive manufacturing (AM) is one of the fastest growing industries and has been widely adopted by the aerospace, automotive, medical, and dental fields. A typical AM process chain is illustrated in the flow diagram presented in FIG. 1. As shown, an exemplary AM process chain comprises step 101 of developing a CAD solid model, step 102 of converting the CAD file to a standard tessellation language (STL) or other suitable file, step 103 of slicing the model into one or more layers, step 104 of converting those layers into G-code, and step 105 of printing the part. Although many file formats, including some specific to AM such as AMF, are available, STL is still the most widely used format. The STL file undergoes further conversion to generate 2D slices of the model, which are then converted to G-code, which defines printer head movement and other processing conditions like temperature and speed. Additive manufacturing machines, sometimes called 3D printers, are capable of producing parts with a layer resolution from hundreds of microns thick to as small as 16 microns thick. Micro- and nano-fabrication methods, such as electron-beam lithography, photolithography, and two-photon polymerization may in some embodiments create 3-D structures with a resolution of 100 nm or lower, sometimes as low as 30 nm. Examples of such printers are described in Mao et al, “The emerging frontiers and applications of high-resolution 3d printing.” Micromachines, 2017. 8(4), and Cumpston et al, “Two-photon polymerization initiators for three-dimensional optical data storage and microfabrication.” Nature, 1999. 398(6722). Printers that are capable of printing at even higher resolution such as nanoprinting have also found applications in tissue engineering, electronics manufacturing, material synthesis/patterning, and drug delivery. In some embodiments, quantum dot (QD) nanoparticles are added into AM parts. A QD is a nanoparticle whose diameter ranges from 2 to 20 nanometers. Due to the high resolution and high geometrical complexity of AM parts, artifacts can be added with complex geometry and unique optical characteristics to serve as a signature, as described by Elliott et al, “An investigation of the effects of quantum dot nanoparticles on photopolymer resin for use in polyjet direct 3D printing,” Proceedings of the 2012 Solid Freeform Fabrication Symposium. Aug. 6-8, 2012. Austin, Tex. It is also experimentally proven that AM printability is not significantly affected by the presence of quantum dots in mass concentrations less than or equal to 0.5%. However, these high value components and applications can be critical in terms of information privacy, intellectual property rights, and human life-threatening events, and are subjected to attacks from all sources, similar to Cyber-Physical Systems (CPS) attacks.

It is understood that the system and methods of the present invention may be used with any material suitable for use in additive manufacturing. This includes, but is not limited to, polymers, including syntactic foam and ABS; metals, including aluminum, stainless steel, and titanium; minerals, including marble, granite, or quartz; or tissue, including muscle tissue, bone, or cartilage.

Aspects of the present invention are directed to various security measures to be implemented in AM and the parts created by AM in order to evaluate the genuineness of 3D printed parts and to detect counterfeit parts or parts made from misappropriated CAD files. Broadly, one aspect of the invention is directed to exploiting the layer-by-layer process of AM to embed a code or proprietary feature inside an AM part. In some embodiments, if not implemented carefully, an embedded code may act like a defect, reducing one or more mechanical properties of the part. In order to remedy this, in some embodiments, a code may be sliced or divided into multiple segments, and those segments spread out to different layers or different regions of the printed part. In one embodiment, for example, a square code may be divided along its height into three equally-sized segments, with each segment arranged in a different layer than the other segments. The divided internal code can then be read using an imaging device, including for example but not limited to an X-ray, a micro-CT scan, or ultrasonic imaging to obtain internal structural scans of the part. The code can then be reconstructed by combining the various slices and reading the resulting code.

In some embodiments, a code might be embedded in the original CAD model. In some embodiments, sections of the model containing the code may use a different material than the surrounding model. In other embodiments, the regions of the layer or layers containing the code may be printed at a different resolution or using a different printing technique than the surrounding CAD model. In some embodiments, the regions of the layer or layers containing the code may be printed using the same or a similar material but in a different color than the surrounding regions. In some embodiments, the CAD model is printed in a material that is substantially translucent or transparent, while the region or regions containing the code are substantially opaque. Whereas some 3D printed parts have simple geometries, many industrial component designs are very complex, making it difficult or impossible to embed security features without easy detection. Embedded codes of the present invention may have any suitable size, and may in some embodiments be smaller than about 30×30×5 mm, smaller than about 10×10×3 mm, or smaller than about 1×1×1 mm in size. In some embodiments, larger codes may be used, including codes about 50×50×10 mm, or 100×100×10 mm. It is understood that when a code is divided among multiple layers as described herein, the thickness of the region containing the printed code may increase to accommodate the additional layers, for example by 200%, 300%, 500%, or 1000%.

In experimental embodiments described below, a quick response (QR) code is used as the embedded security feature. A QR code is a type of two-dimensional barcode that is machine-readable and can be attached as an optical label to an item. Information is encoded in both vertical and horizontal directions, and a QR code therefore has the capacity to store several hundred times more data than a traditional barcode. The encoded information can be easily assessed by capturing an image of a QR code with a camera or other digital imager and processing that image with a QR code reader. Several online resources provide free generation of either static or dynamic QR codes. A static QR code refers to a QR code whose encoded data represents a fixed permanent address, while a dynamic QR code refers to a QR code whose encoded data points to a dynamic address, for example a short link or a redirectable URL. Dynamic QR codes thus allow users to change the final destination address represented by a QR code without changing the code itself. When a destination address is changed, a dynamic QR code will automatically redirect all future scans to the new content. In some embodiments, embedded QR codes of the present invention are static QR codes, but in other embodiments, dynamic QR codes may be used. In still other embodiments, QR codes of the present invention represent fixed text content, for example a unique serial number. In some embodiments, QR codes of the present invention may comprise a quantity of binary data encoded in BASE64 or some other suitable ASCII character encoding format.

QR codes are advantageous for security applications because individual codes can be designed with error correction and detection features built in. In some embodiments, the QR code is added to the final model design. In other embodiments, part or all of the QR code may be changed or incremented during manufacturing, in order to serve a dual function as a unique serial number for each part manufactured. In some embodiments, some or all of the QR code may be used to indicate the date and time of manufacture, the serial number of the printer used to manufacture the part, or any other information about manufacture desired to be embedded in the finished product. In this way, parts of the QR code may be used similarly to date stamps or mold IDs in existing, conventionally-manufactured parts. By embedding the code within a part, the security measures of the present invention are particularly resilient to reverse-engineering, for example by 3D scanners, stereoscopic imaging, or other methods of computer-aided capture of 3D models. If a counterfeiter were to image a part with the intention of creating a 3D model based the part's contours and appearance, the 3D imaging would fail to capture any internal features, including the QR code. The absence of the QR code in the illicitly-duplicated part could then be used as an indicator that the part is a counterfeit.

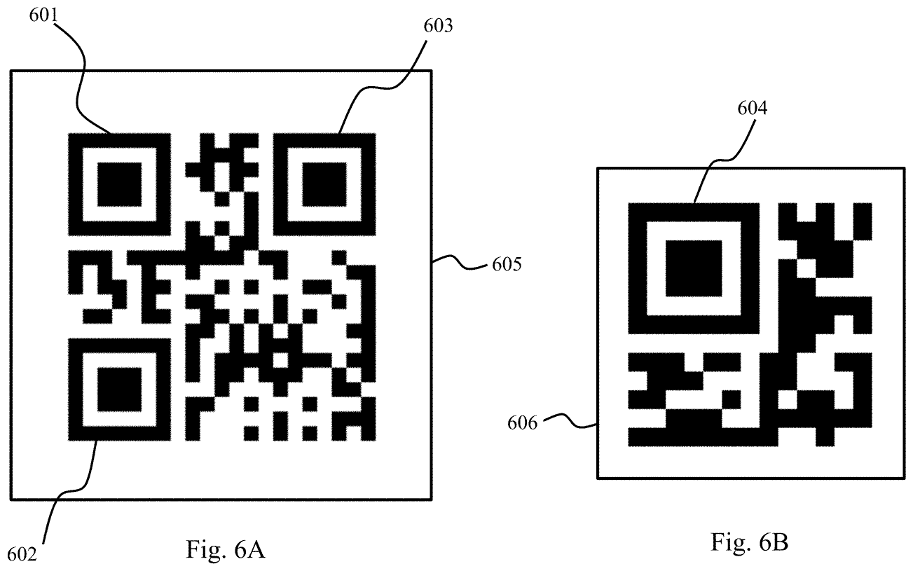

QR codes used in the present invention may have a variety of sizes, types, and data capacities, depending on the desired application. For example, a standard QR code as shown in FIG. 6A may be used, or alternatively a micro-QR code may be used as shown in FIG. 6B. It is understood that the QR code standard includes a variety of error correction levels, wherein a quantity of redundant error correction or “backup” data is added to the encoded data payload in order to be able to detect or correct bit errors in a QR code. The backup data added is categorized in “levels” based on how much damage the QR code is expected to suffer in its intended environment. The standard levels and their error correction rates are listed below in Table 1.

TABLE 1

| | Maximum Damage |
|---|---|
| Level | Tolerance |
| L | 7% |
| M | 15% |
| Q | 25% |
| H | 30% |

The maximum data capacity and error correction levels available for micro-QR codes is shown in Table 2 below. As shown, micro-QR codes are smaller and thus have lower data capacity than standard QR codes, but may still be viable for applications where a short code is needed inside a small physical envelope.

TABLE 2

| Symbol Version | Number of Modules | Error Correction Level |
|---|---|---|
| M1 | 11 | None |
| M2 | 13 | L |
| | | M |
| M3 | 15 | L |
| | | M |
| M4 | 17 | L |
| | | M |
| | | Q |

In some embodiments of the present invention, the embedded code is a conventional 1D zebra-stripe barcode, such as a UPC code used for commercial products. 1D barcodes encode data horizontally only using black bars on a white background, which are sufficient for storing information such as numbers or short tags. For a longer string field, however, such 1D codes are insufficient. Despite their limited information storage capability, one dimensional barcodes are still widely used, because readers are ubiquitous and the coding scheme is universally understood.

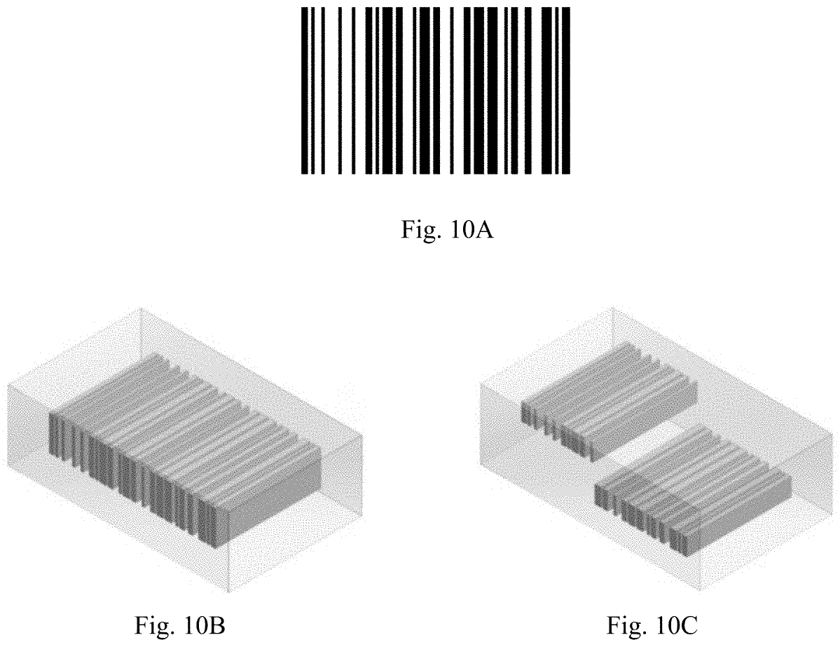

An example of a 1D barcode is shown in FIG. 10A. The 1D barcode shown uses the code 128 encoding scheme, and its content is the string “CMML.” Although code 128 encoding is used in the depicted example, it is understood that 1D barcode embodiments of the present invention could use any 1D or linear barcode encoding scheme, including but not limited to Code 11, Code 39, Code 93, Code 49, EAN 2, EAN 5, EAN-8, EAN-13, UPC-A, UPC-E, Intelligent Mail Barcode, Phrarmacode, POSTNET, PostBar, Plessey, or any other linear bar code coding scheme known in the art. In some embodiments, embedded codes of the present invention may comprise more than one linear coding standard, or may alternatively include one or more alphanumeric characters embedded with the code in order to provide further information or visual validation of the contents of the code.

Aspects of the present invention relate to methods of embedding CAD features in solid models. It should be understood that any introduced features must be included in the design of components with significant planning and forethought as to the potential impact on the structural integrity of the finished part. Only by using a careful combination of parameters and practices through the AM process chain can a CAD feature be added to an existing model while still producing a high quality component. The combination of parameters and practices serves as a second layer of security, because a counterfeiter copying a part without the proper process in place will necessarily produce a part of measurably lower quality. That lower quality can then further be used to separate genuine parts from counterfeits.

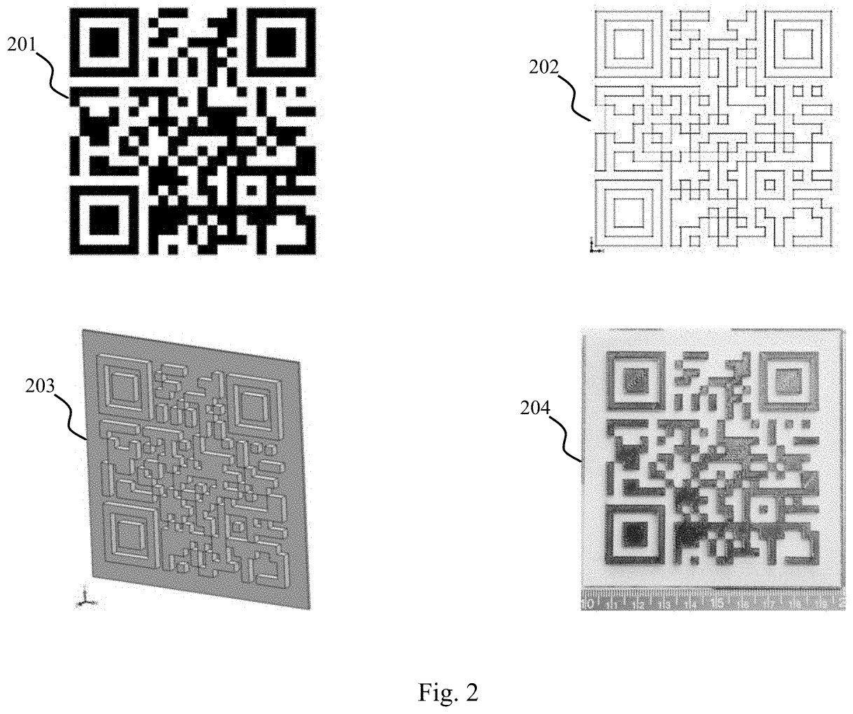

In some embodiments, methods of the present invention comprise the steps of generating and printing a QR code for use as an embedded security feature. Exemplary phases of a QR code generation process of the present invention are shown in FIG. 2. First, a two-dimensional QR code 201 is generated, for example using an online resource. This image is then imported into a 3D modeling software, for example SolidWorks or AutoCAD, for digitization. The 2D digitized code sketch 202 is converted to a 3D CAD model file 203 with physical attributes such as volume and thickness. The original QR code 201 comprises a series of black squares arranged on a white background. In the 3D model, the black areas are extruded with certain thickness. The 3D model is then exported to STL and, in some embodiments, is sliced into multiple parts for embedding in different layers or regions of the finished part. In some embodiments, a coarse resolution is used, but in other embodiments, different resolutions may first be tested in order to pick the resolution that provides the minimum overlapping and failure at disconnections when STL files are converted into sliced models of 2D toolpaths. Following the workflow in FIG. 1, a 3D printed scannable code model 204 can be produced.

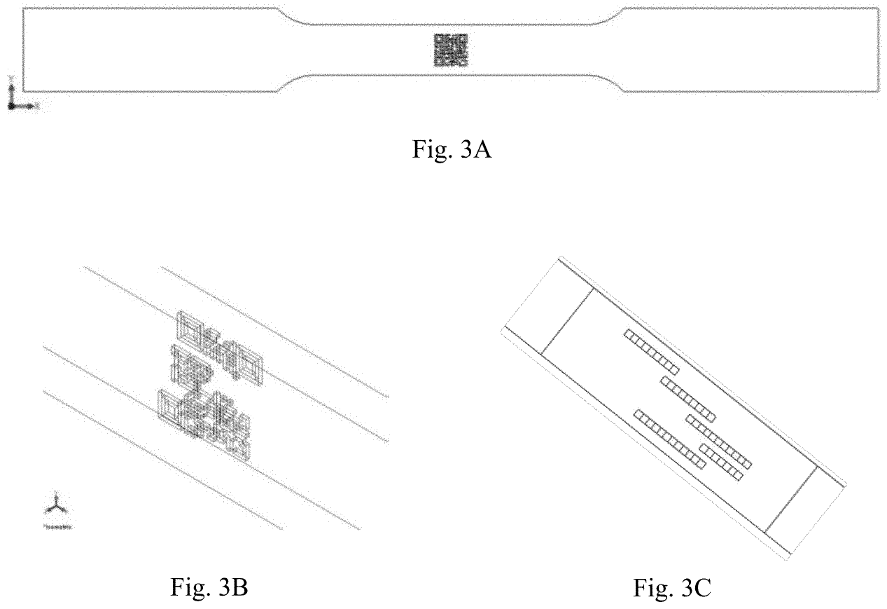

In some embodiments, the generated QR code requires some amount of manual clean-up prior to or during printing. Particularly in embodiments where the QR code is broken into slices, as shown generally in FIG. 3A-FIG. 3C, features at the edges of slices may need to be manually augmented in order to be read properly by subsequent imaging. In some embodiments, for example, the slicing step will erroneously drop connections between lines which previously met at corners. These dropped connections may result in gaps between lines that change the shape of the code, impeding scanning. Depending on the printer resolution, the spacing between parallel lines may also vary across the code. This process is obviated by a program code digitization processing and reading process of the present invention, based on contrast between the featured and non-featured space in the code. In some embodiments, a discrepancy matching algorithm is provided to validate the code authenticity with pre-determined confidence. In some embodiments, the sliced code is first rendered in 3D and one or more 2D snapshots are captured in order to validate the readability of the 3D generated code prior to printing.

In some embodiments, methods of the present invention comprise a step of splitting a code into several parts and embedding various parts in different print layers. This approach serves at least the following two purposes: (1) avoiding structural integrity issues, and (2) making sure that the code is imaged correctly only from a very specific angle. Such embedded codes will be invisible from the surface. FIG. 3A-FIG. 3C show an example of a QR code embedded in a standard tensile test specimen. The front view of the specimen FIG. 3A shows an exemplary complete code that can be scanned. An isometric view of the same 3D model is shown in FIG. 3B. The isometric view shows that the code is divided into five parts, and that each part is embedded at a different depth in the specimen. Though FIG. 3A-FIG. 3C show a code broken into five parts, it is understood that a code can be broken into fewer than or more than five parts as necessary. For example, a code may be broken into 2 or more, 3 or more, 10 or more, 20 or more, 25 or more, or 50 or more, or 100 or more parts. In some embodiments, multiple parts of the code are distributed into different regions of the printed part. The different slices or parts of the code may in some embodiments have additional orientation or position information added to make it easier to combine them together to form the final code for evaluation. As shown in FIG. 3B and FIG. 3C, imaging a sliced code from any other angle except for the front side will not provide a scannable code. This is important because industrial components are often complex in shape and unsuspecting people may not be able to easily figure out the correct orientation to image an embedded code.

In some embodiments, methods of the present invention include imaging steps directed to extracting an embedded code from within a part created via an AM process. In some embodiments, a micro CT scanner is used to image and reconstruct codes embedded within a printed part. A micro CT scanner may be used to collect images from some or all of the regions of the printed part, or may alternatively only collect those CT scan image slices that contain the code information that will be separated and overlaid to reconstitute the code. It is understood that other methods of scanning suitable for the application could also be used, including but not limited to X-ray, Magnetic Resonance Imaging (MRI), ultrasonic, infrared or ultraviolet illuminated imaging.

In some embodiments, the reconstituted code is represented by a grayscale image, which may be an 8-bit grayscale image. In other embodiments, the reconstituted code may be a color image, or may alternatively be a 10-bit, 12-bit, 16-bit, or 32-bit grayscale image as needed.

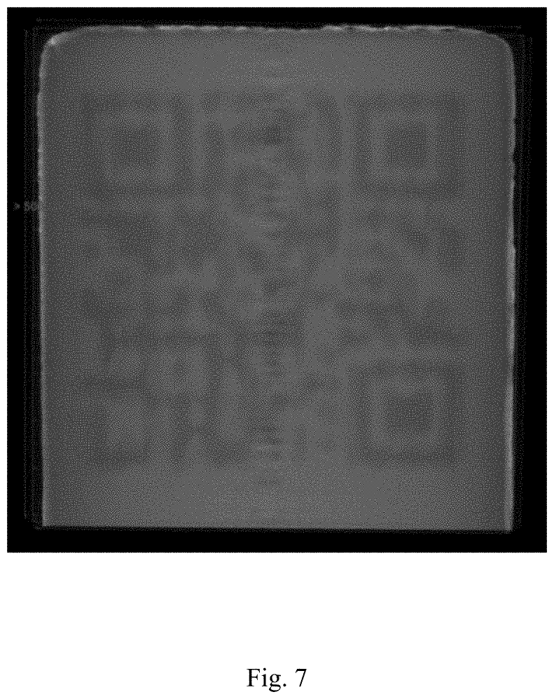

In some embodiments, the reconstituted code derived from the CT scan may lack sufficient resolution or contrast to be simply scanned by a smartphone-based or other computer vision based scanner. An exemplary reconstituted QR code, shown in FIG. 7, appears visible and clear to the naked eye, but is not able to be scanned by a computerized barcode scanner. In some embodiments, methods of the present invention comprise steps of comparing the resultant code to the original code via an overlay or other image processing method to determine deviation from the original code.

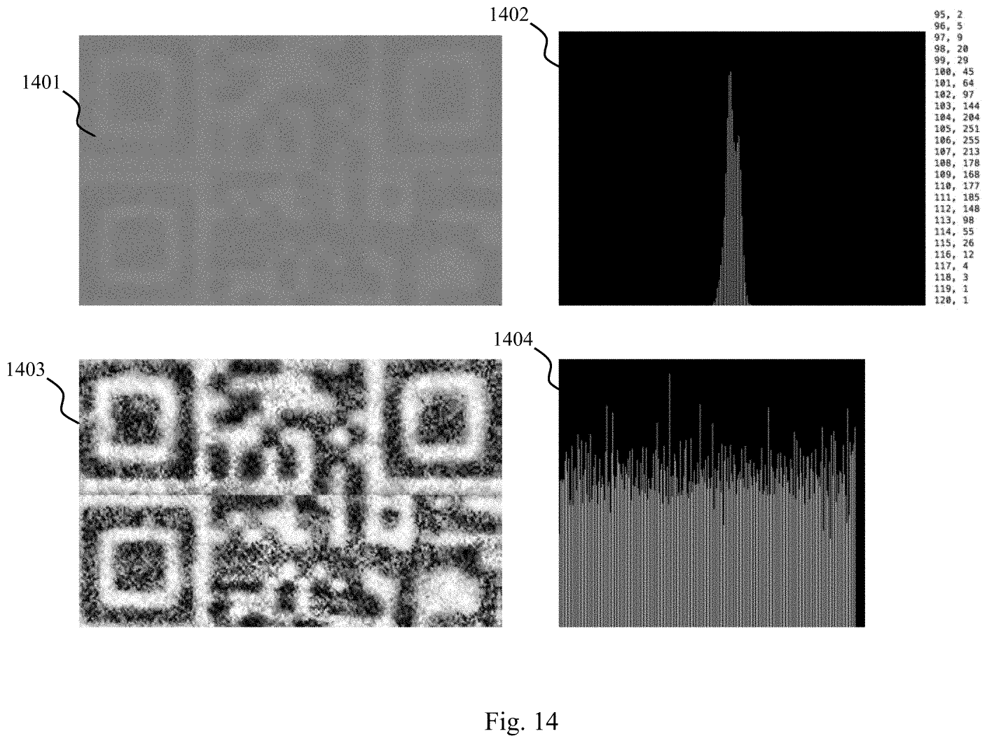

Methods of the present invention may include one or more image processing steps, for example conversion of a grayscale image that might have low contrast into a binary image for easier processing. In some embodiments, one image processing step is to apply an adaptive histogram equalization, particularly if the color gamut of the grayscale image is low. One example of an adaptive histogram equalization method is the Contrast Limited Adaptive Histogram Equalization (CLAHE), provided by OpenCV. By applying multiple iterations of the CLAHE or other histogram equalization algorithm, an image having a tight histogram of color values may be usefully processed into an image with a wider gamut, showing two distinct peaks which can be used to differentiate between black and white points in the image. An example of such an image enhancement is shown in FIG. 14. In some embodiments, the method comprises running a CLAHE for 1-20 iterations, in other embodiments, the method comprises running a CLAHE for 10 iterations. After obtaining a properly equalized histogram, methods of the invention may comprise the step of determining a local minimum between the two peaks as a dividing point, and assigning pixels above the dividing point one color, and pixels below the dividing point another color, in order to produce an image with enhanced contrast. In some embodiments, pixel values around known features, for example the square position detection elements, may be used in order to determine a suitable dividing point, in addition to or in place of the one or more CLAHE iterations.

In some embodiments, imaging and scanning methods of the present invention comprise steps of comparing an image of a code taken from within an AM part with the original code embedded within the part in order to validate it. This comparison step may comprise a contour detection step, for example to better determine in an automated fashion the sizes and positions of the position-detection features or other fixed position elements in order to better rectify the code image for comparison. In some embodiments, based on the size and position of the position detection features, a grid size is determined in order to translate or down-sample the pixel resolution of the taken image into the feature size of the original code. This allows for easy overlay of the original code onto the rectified image, in order to perform a comparison. In some embodiments, the comparison is conducted with multiple different grid sizes, and the results taken together, in order to calculate the comparison with higher confidence. In some embodiments, one region of a scanned code may be evaluated at one grid size, while another region is evaluated at another grid size. In some embodiments, the grid elements are squares, but in other embodiments the grid elements may have differing length and width, for example to correct for scanning orientation or non-uniform printer resolution.

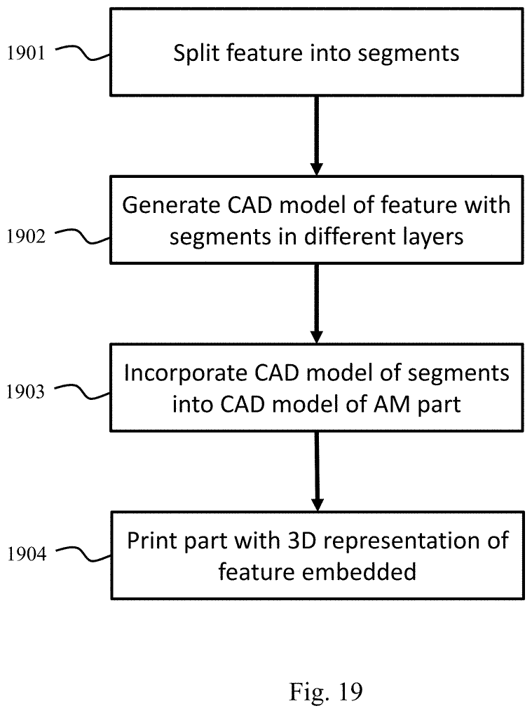

Referring now to FIG. 19, a method of the present invention is shown. As depicted, a method of embedding an identifying feature into an additively-manufactured part comprises the steps of splitting an image of an identifying feature into a plurality of segments 1901, generating a CAD model of the identifying feature with each of the plurality of segments positioned in a different layer of the CAD model 1902, incorporating the CAD model of the identifying feature into a CAD model of an additively-manufactured part 1903, and printing an additively-manufactured part containing a three-dimensional representation of the identifying feature, using the CAD model of the additively-manufactured part 1904.

### Experimental Examples

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out exemplary embodiments of the present invention, and are not to be construed as limiting in any way the remainder of the disclosure.

Materials and Methods SolidWorks 2015 is used in this example as the primary CAD solid modeling software. Depending on the type of 3D printer used, different slicing software preparation tools are used correspondingly. For parts that are 3D printed with a fused deposition modeling (FDM) printer Stratasys Dimension Elite, the part model material is acrylonitrile butadiene styrene (ABS) thermoplastic filament and CAD solid model development support material is a water-soluble material (SR-10TM/P400SRTM soluble support material-acrylic copolymer). In this embodiment, the CatalystEX slicing software is used for toolpath generation and encoder file preparation. Table 3 below shows two possible layer resolutions for use when slicing the model and generating the toolpath. Layer resolution refers to the thickness in the vertical Z direction of each layer during the deposition process, where lower layer resolution generally gives higher precision. In addition to layer resolution, the model interior may be printed in any of a variety of infill densities, including “solid”, “high-density”, and “low-density”. As used herein, the “solid” option provides 100% infill and therefore the densest part, and so therefore the “solid” model interior is chosen for all models processed in CatalystEX in this example.

TABLE 3

| | Layer | X/Y | Minimum |
|---|---|---|---|
| | Resolution | resolution | Feature Size |
| Printer Specification | (mm) | (mm) | (mm) |
| Stratasys Dimension | 0.254 or 0.178 | N/A | N/A |
| Elite | | | |
| Stratasys Mojo | 0.178 | 0.5 | 1 |

In addition to FDM technology, the Polyjet technology with finer layer resolution (down to 16 microns) is also adopted in this work to facilitate higher precision fabrication and feature miniaturization. The Stratasys J750 Polyjet 3D Printer is used to produce multi-material parts with high resolution using VeroWhite and VeroBlack photopolymers. The Stratasys Objet30 Pro 3D printer is used to produce parts with embedded features in high resolution using VeroClear photopolymer.

The QR code was then generated as shown generally in FIG. 2. The 3D model 203 was exported to STL at a variety of different resolutions and tested for printing and scanning performance. For the purposes of this experiment, the QR code area in the 3D model was 250 mm×250 mm, with a height of 10 mm on the extruded code features. The base of the model, from which the code area is extruded, measures 300 mm×300 mm×3 mm. Printed code 204 measures 83 mm×83 mm, with a thickness of 3.32 mm. Both the original code 201 and the printed code 204 were capable of being scanned by a smartphone-based QR code reading app.

As discussed above, the example shown in FIG. 2 required meticulous manual work to clean up the code in the sliced file in order to ensure that the code was printed correctly. This process is obviated by a program code digitization processing and reading process of the present invention, based on contrast between the featured and non-featured space in the code. In some embodiments, a discrepancy matching algorithm is provided to validate the code authenticity with pre-determined confidence.

### QR Code Printing

QR codes were printed using three widely-known 3D printing technologies: (a) polymer FDM using Stratasys Dimension printers, (b) photopolymer using Objet30 Pro and (c) AlSi10Mg using metal printer EOS M280. Each of these printers is capable of printing at a different resolution. The codes were printed in multiple sizes to determine the QR code line width capable of being scanned using a QR code reader.

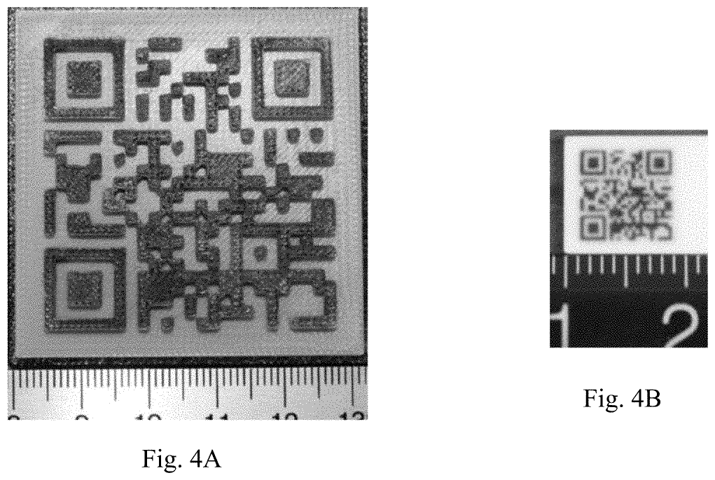

Two examples of 3D printed QR codes are shown in FIG. 4A and FIG. 4B. The code in FIG. 4A was printed by a Stratasys Dimension printer and measures 42×42 mm in size, and 1.68 mm thick. The code was able to be scanned by a QR code reading app on a smartphone. The individual line size in such FDM printers is approximately 0.4 mm, which makes it possible to reduce the size of this code. However, the digitized initial code needs to be sliced before printing. A number of connections between features are lost during the slicing process when the line resolution is below a certain size, and so the actual miniature version of this code required a line width of approximately 1 mm. This limitation means that the minimum size of such a code is approximately 12×12 mm, and such a code would require significant repair of the sliced model in order to be printed correctly. Similar limitations apply to other technologies, but the print resolution is much finer for photopolymerization and SLS printers. FIG. 4B is a Polyjet resin print of the same code. This code was scaled down to 8×8 mm and 1.2 mm thick, with only a small amount of manual repair needed in the sliced model. However, this code can be miniaturized to less than 1×1 mm with well resolved features due to the very fine resolution of the resin printers. Later analysis will also be conducted using SLS printers with aluminum alloy to determine the size that can be printed and resolved. It is expected that an SLS printer using a 40 μm average particle size would be capable of printing a 1×1 mm readable code. Smaller codes are photographed, enlarged and then scanned in order to determine their readability.

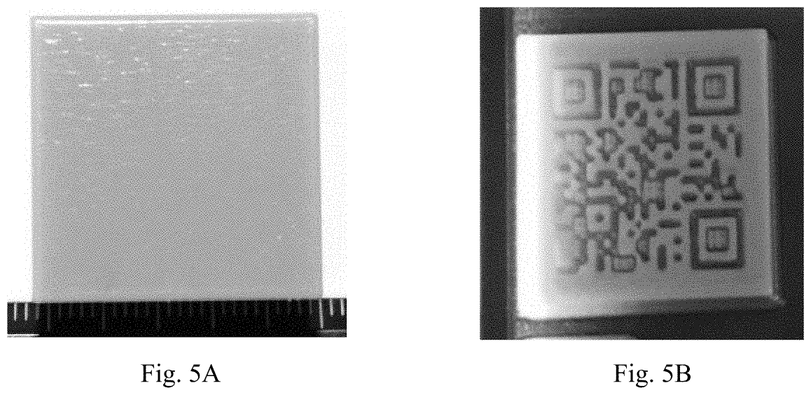

FIG. 5A and FIG. 5B demonstrate the effectiveness of printing a QR code on an internal layer of a 3D model. The QR code visible in FIG. 5B was printed in Veroblue photosensitive material using an Objet30 Pro. The completed part, with the code embedded and therefore not visible from the surface, is shown in FIG. 5A. FIG. 5B shows an image of the embedded code, taken during printing. In the example shown in FIG. 5B, the code is printed on a single layer, but it is understood that the code could be sliced and distributed among multiple layers.

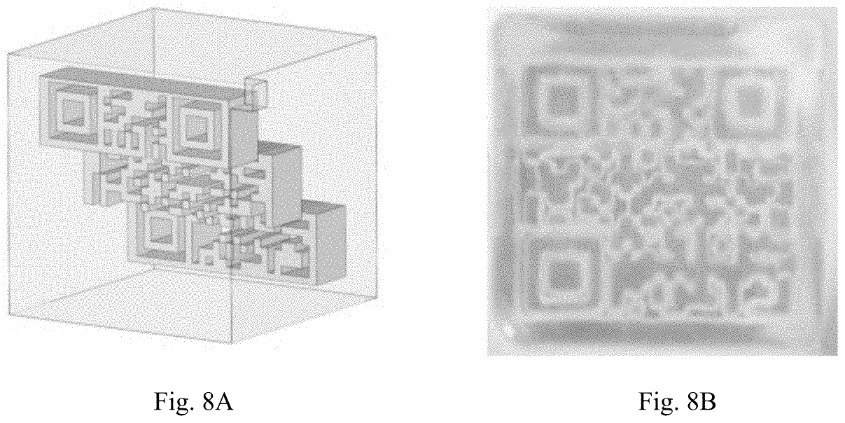

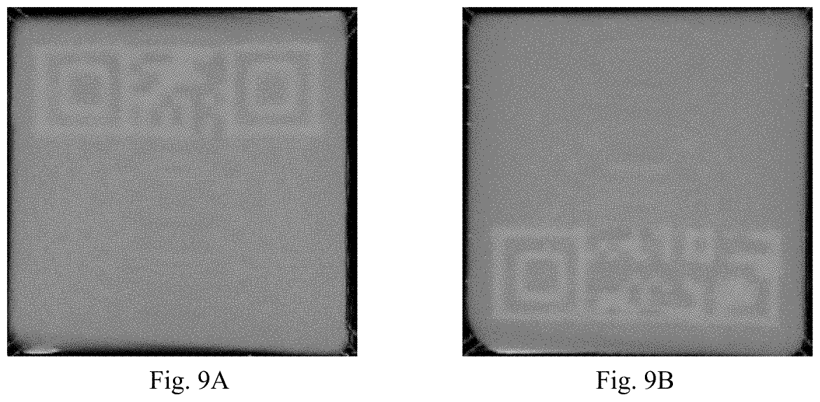

An example of a sliced, printed, and reconstituted code is shown in FIG. 8A and FIG. 8B. As shown in FIG. 8A, the 2D complete QR code was sliced into 3 sections and embedded at different depths within the same solid cube. The multi-segmented QR code model as shown in FIG. 8A was 3D printed in VeroClear photosensitive polymer using Objet30 Pro, which is capable of printing at a resolution as precise as 16 μm. The 3D printed part, shown in FIG. 8B, was then scanned using X-ray computed tomography (CT-scan), and image reconstruction was performed on the 3D imagery to reveal internal information. The top and bottom QR code segments can be visualized from the representative reconstructed slices, examples of which are shown in FIG. 9A and FIG. 9B. The reconstructed images are then subjected to image processing for pattern recognition and discrepancy calculation.

### QR Code Miniaturization

As shown in FIG. 6A, a standard QR code has three position detection elements 601, 602, and 603. A micro-QR code, shown in FIG. 6B, has only a single position detection element 604. This means that micro-QR codes are more compact, but also more prone to background interference. As shown, a standard QR code requires a “quiet zone” 605 (i.e. a region that is required to be featureless in order for the code to be read successfully) that is four modules wide. By contrast, a micro-QR code has a 2-module wide quiet zone, thereby allowing it to fit in a smaller envelope. The biggest difference between standard QR codes and micro-QR Codes is their size and hence storage density. A traditional QR code as shown in FIG. 6A handles 7089 numeric characters, whereas a micro-QR code may only contain up to 35 numeric characters. The QR codes shown in FIG. 6A and FIG. 6B are both encoded with the same character string, “CMML.”

### QR Code Scanning and Reading

A micro CT scanner was used to image and reconstruct embedded codes. The preliminary result of a CT scan of an embedded code for one resin printed specimen of 1×1 mm size is shown in FIG. 7. To the human eye, this code may seem well-resolved, but poor contrast and resolution in areas where lines are closely spaced means that automated scanners are unable to scan it.

It is also noted that the micro CT-scan can provide a 3D reconstruction of the entire code specimen. However, the actual readable QR code is only a 2D image. Therefore, only the CT-scan image slices that contain QR code information are separated and overlaid to construct the reconstituted code. This method reduces scan time and the total amount of data that needs to be stored and processed, by only using a limited set of scan images rather than the entire CT-scan output, which can be as large as 10-100 GB, or more.

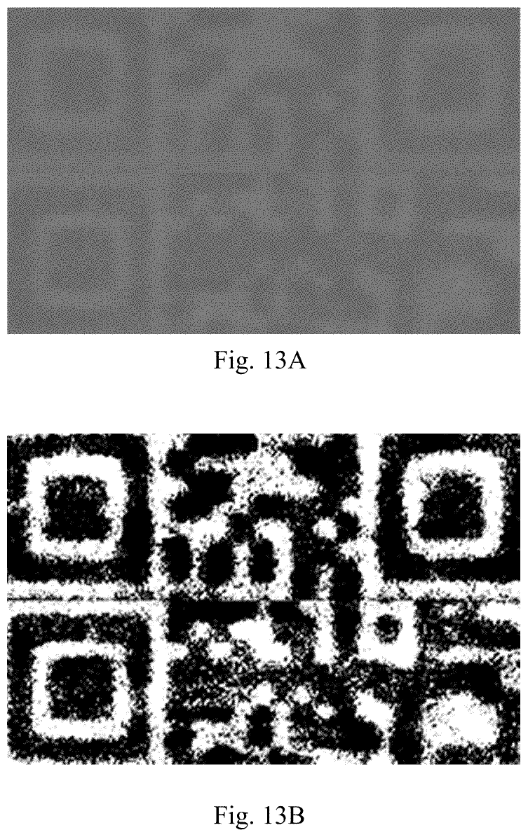

To perform image processing, the two representative images shown in FIG. 9A and FIG. 9B are combined into one image, for example using Adobe Photoshop CS6 as shown in FIG. 13A. In order to ease processing and scanning, the grayscale image of FIG. 13A must be converted into a binary image as shown in FIG. 13B. This is accomplished by selecting a threshold value and converting every pixel above the threshold value to 255 (white) and below to 0 (black) such that the finished image contains only black and white pixels, achieving maximum contrast. Although 8-bit grayscale is used in the present example, it is understood that higher quantization imaging may yield better results, and that 10-bit, 12-bit, 16-bit, or 32-bit grayscale images may also be used where practical. In order to obtain the high contrast image, an automatic image processing system was developed using algorithms built in OpenCV software, a library of premade computer vision functions designed to process images, and under a virtual environment enabled by Python. To obtain the optimal threshold value for the grayscale image, its intensity histogram is calculated. However, the original grayscale image has a rather small range of grayscale values in its intensity histogram, due to the low contrast of the image. FIG. 14 depicts an example original grayscale image 1401 and accompanying intensity histogram 1402. From this narrow histogram, it is difficult to recognize patterns, as is evident from 1401. Therefore, a wider histogram was obtained using an equalization method called adaptive histogram equalization, applied to the original grayscale image. This method can help preserve enough details of the image and avoid over-exposure during image processing. The algorithm used herein is Contrast Limited Adaptive Histogram Equalization (CLAHE) provided by OpenCV. This algorithm is applied on the calculated histogram from the original grayscale image to help obtain a histogram with a wider gamut of intensity values and distinct local extremes as shown in FIG. 14B. The CLAHE algorithm was tested with different numbers of iterations, in order to understand the effects of running multiple iterations and to determine the optimal number. Images were generated from 1, 5, 10, 15, and 20 iterations and compared. For more than 1 iteration, the CLAHE processed image showed noticeable noise reduction. For iterations after 10, no significant improvement was observed and the processing time per iteration increased. After obtaining the properly equalized histogram, the optimal threshold value was determined by selecting the local minimum of two peaks in the range of 95 to 120 grayscale values as indicated by the original histogram 1402. This selection process is then implemented in OpenCV to automatically apply the optimal threshold value to the CLAHE image and return the final processed binary image 1403.

Discrepancy Calculation

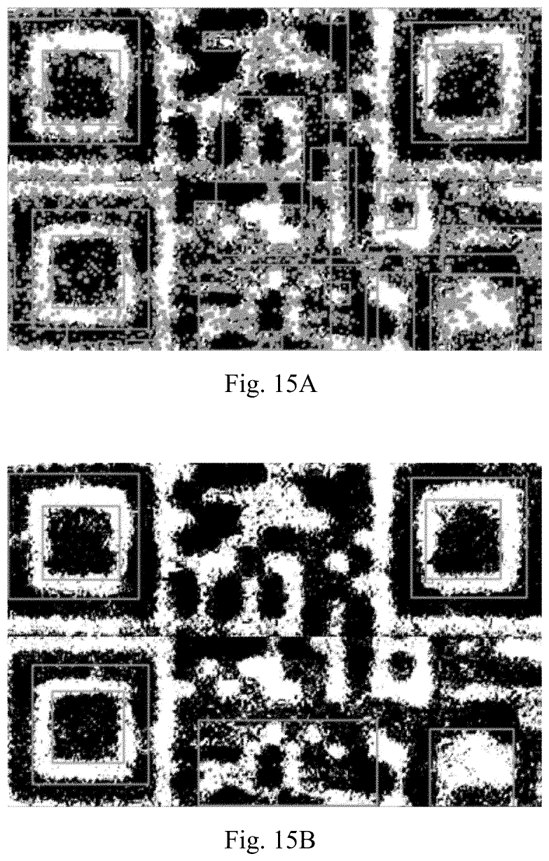

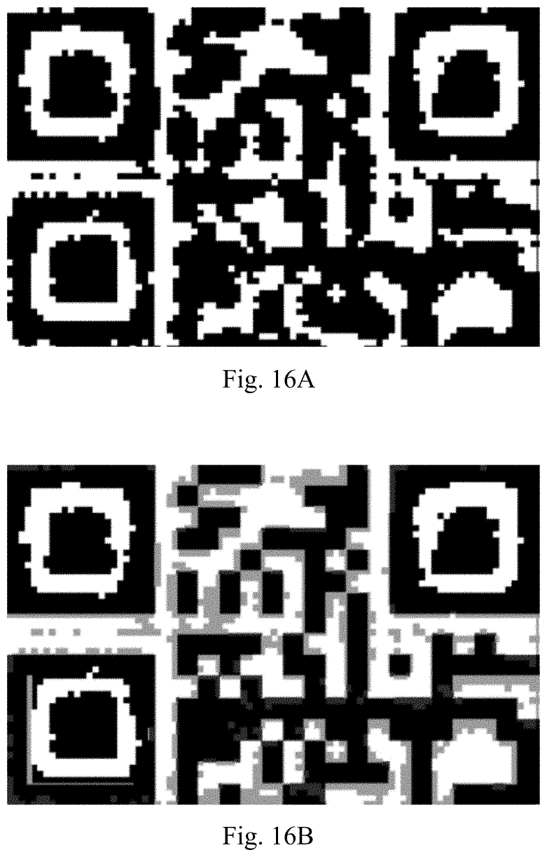

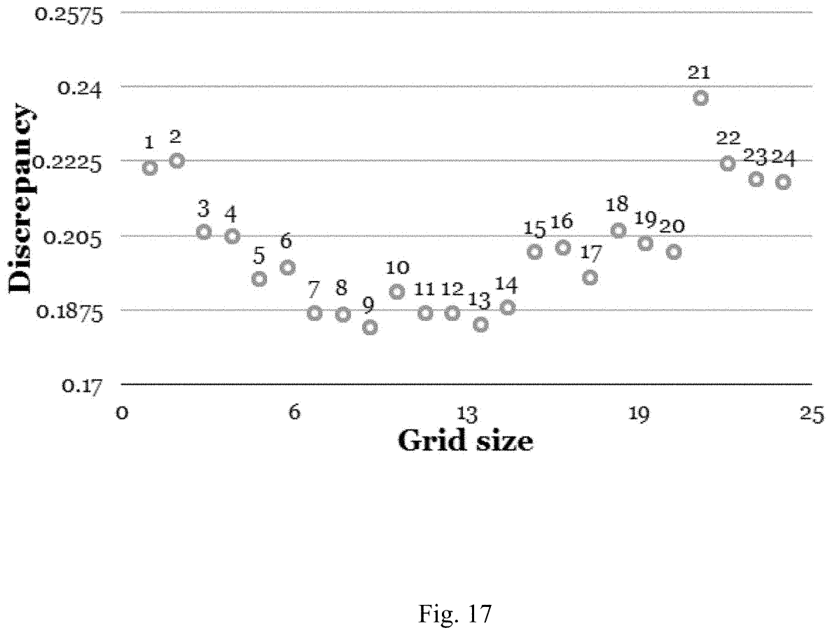

The reconstructed and processed QR code image was compared to the original QR code pattern to determine the level of similarity by calculating the discrepancy, i.e. the pixel-by-pixel differences between the original code pattern and the processed code image. First, a contour detection method is used to detect the three positioning markings by the unique contour hierarchy of these positioning squares. The contour detection method is applied to the processed image and the result shows that contours are detected indiscriminately, as shown in FIG. 15A. A variety of methods were used to reduce noise and eliminate erroneous contour points. As shown in FIG. 15B, contour detection in the processed image was able to detect the three positioning marks, in the top left, top right, and bottom left corners. The contour detection algorithm also erroneously detected other contours, for example in the bottom middle and bottom right of the image in FIG. 15B. One approach to mitigate this is to check the shape of the rectangle and compare that shape with the expected feature size. Another approach is to check the relative positions of the various rectangles and include only those features positioned in relative similarity to the corresponding features in the standard QR code pattern. Once the positioning markings are obtained and removed from the processed image, the remaining QR image, which represents the actual information encoded in the QR code, is used for calculating the discrepancy. The processed image without positioning squares is first divided into many small blocks, within which the average of grayscale value across all pixels is calculated. All pixels in the block are then converted to white if the average grayscale value is larger than 50% and black if the smaller than 50%. The grid size selected impacts the effectiveness of the comparison between the gridded processed image and original QR image. Therefore, the discrepancy value is calculated for a series of grid sizes to determine the most suitable one as shown in FIG. 17. In the depicted example, excluding positioning squares, a grid of size 9 gives the lowest discrepancy 0.1832 and hence is used for turning the processed image into a gridded image as shown in FIG. 16A. To better facilitate the identification process, the areas of discrepancy between the original QR code image and the processed gridded image can be highlighted in colors as shown in FIG. 16B. Green areas represent areas that were white in the original code but are black in the processed gridded image, while blue areas indicate the opposite—areas that were black in the original code but are white in the processed gridded image. The final discrepancy calculation shows that the black discrepancy (colored blue in the gridded image) is 0.03777601776261457, and the white discrepancy (colored green) is 0.14545848395001557. The final discrepancy value is the sum of these two, 0.183234501713 for the overall image excluding the positioning squares.

### Linear Code Printing

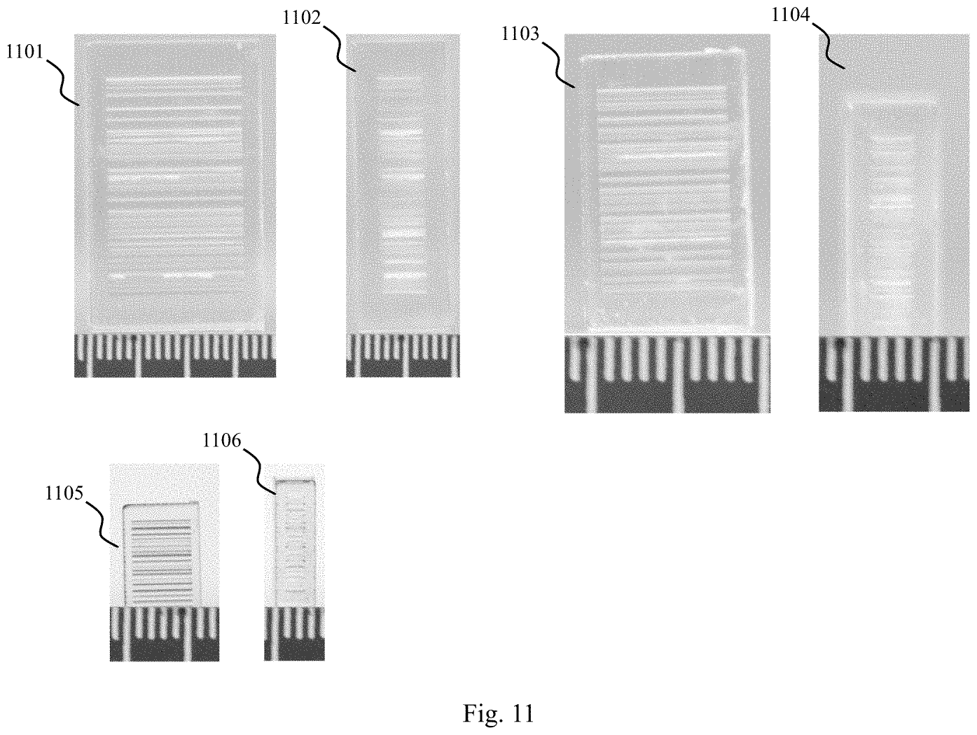

Two 3D CAD models were created in SolidWorks 3D modelling software as shown in FIG. 10B and FIG. 10C, using the code 128 code shown in FIG. 10A. The pattern was embedded and extrude-cut from a solid prism at the same depth in the 3D model shown in FIG. 10B. Shown in FIG. 10C, the barcode was segmented into two parts and embedded at different depths. Both CAD files were subjected to the additive manufacturing workflow as in FIG. 1 and printed using VeroClear transparent photopolymer for easier visualization and confirmation of internal features. Shown in FIG. 11 are three exemplary single-depth printed linear barcodes. The first example has dimensions of 30×18×10 mm, and is shown in front view 1101 and side view 1102. The second example is 15×9×5 mm, and is shown in front view 1103 and side view 1104. The third example is 10×6×3 mm, and is shown in front view 1105 and side view 1106. Rulers are included along the bottom of all the elements shown in FIG. 11 to depict scale.

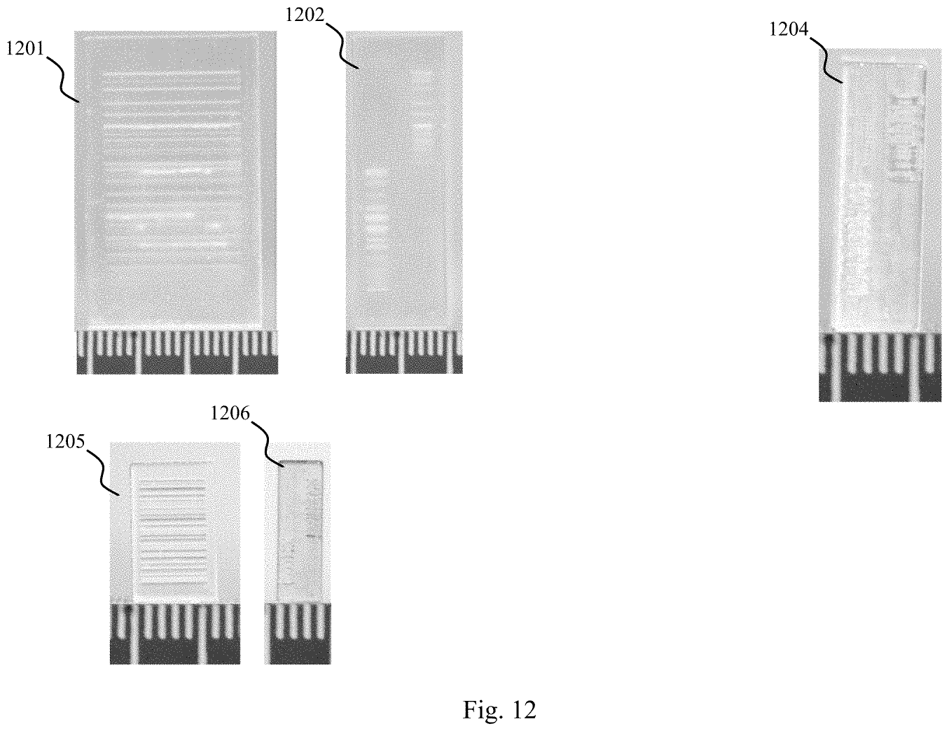

Shown in FIG. 12 are three exemplary two-depth printed linear barcode parts. The first example has dimensions of 30×18×10 mm, and is shown in front view 1201 and side view 1202. The second example has dimensions of 15×9×5 mm, and is shown in side view 1204. The third example has dimensions of 10×6×3 mm, and is shown in front view 1205 and side view 1206. The examples of FIG. 11 and FIG. 12 show the viability of embedding a wide variety of different identifying codes in parts manufactured using AM at high resolution settings with miniaturized geometry. In addition, the multi-segmented model successfully demonstrates the idea of embedding identifying codes using multiple layers at different depths, which makes it more difficult for unauthorized personnel to find the single imaging direction for reading embedded codes.

### Tensile Testing

In order to be effective, embedded codes should have little or no impact on the structural and material properties of the part in which they are embedded. In order to test this, several tensile test specimens were designed with and without embedded codes. The various specimens were printed and mechanically tested in order to determine the effect of the presence of these codes on the tensile strength and modulus of the specimen.

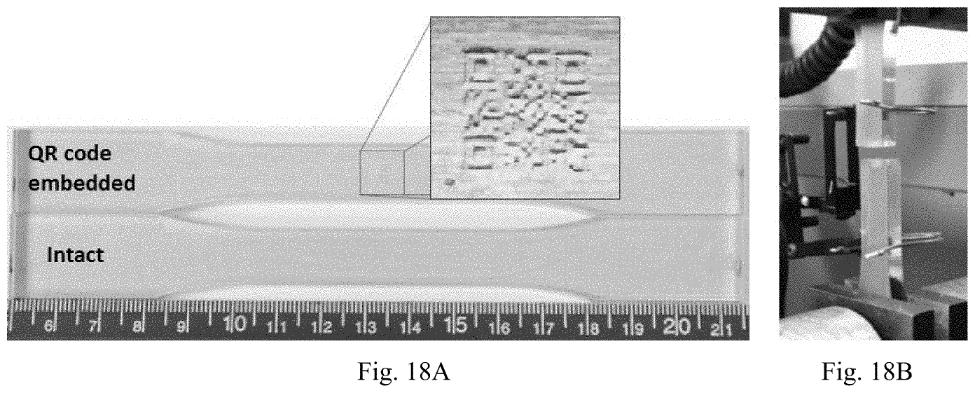

A three-layer segmented code, similar to the one shown in FIG. 8A, was embedded at different depths in a standard tensile bar CAD model. The QR code area is designed to be 4.5×4.5 mm square, and they were embedded in a bar having a width of 13 mm. The code was embedded with a depth of 0.5 mm (bar thickness 7 mm) for each layer. The tensile bars with embedded codes were printed in the initial XY orientation in VeroClear photopolymer using PolyJet technology (Stratasys Objet30 Pro) as shown in FIG. 18A. All 3D printed tensile bars were tested using an Instron test system. Coupons without embedded codes were also printed and tested to obtain baseline properties. Standard tensile tests were performed on all 3D printed tensile bars under the strain rate 0.1 mm/mm·min in accordance with ASTM D638. All the QR code embedded XY printed tensile bars broke at the center area where the QR code is embedded as shown in FIG. 18B. As summarized in Table 4 the averaged ultimate tensile strength and modulus obtained from tensile testing show around 2% and 0.4% difference respectively between the intact bars and QR code embedded bars.

TABLE 4

| | Intact Bars | QR Embedded Bars |
|---|---|---|
| Tensile Strength (MPa) | 57.07 ± 0.44 | 55.92 ± 0.98 |
| Modulus (GPa) | 2.57 ± 0.12 | 2.56 ± 0.11 |
| Weight (g) | 21.80 ± 0.02 | 21.79 ± 0.02 |

With a hardly recognizable difference in weight (0.05%), the tensile properties are not changed significantly by adding an embedded QR code. This proves that embedding identifying codes into a CAD model can serve as an authentication signature in the final product without compromising product quality.

1. A method of embedding an identifying feature into an additively-manufactured part, comprising the steps of:
splitting an image of an identifying feature into a plurality of segments;
generating a CAD model of the identifying feature with each of the plurality of segments positioned in a different layer of the CAD model;
incorporating the CAD model of the identifying feature into a CAD model of an additively-manufactured part; and
printing an additively-manufactured part containing a three-dimensional representation of the identifying feature, using the CAD model of the additively-manufactured part.

2. The method of claim 1, wherein the identifying feature is selected from the group consisting of a QR code and a linear barcode.

3. (canceled)

4. The method of claim 1, wherein the entirety of the identifying feature fits within a region of the additively-manufactured part having a size no larger than about 5 mm×5 mm×5 mm.

5. (canceled)

6. The method of claim 1, wherein the additively-manufactured part comprises at least one selected from the group consisting of: a photopolymer and aluminum.

7. (canceled)

8. The method of claim 1, wherein the identifying feature comprises a plurality of black elements and a plurality of white elements.

9. The method of claim 8, wherein the regions of the three-dimensional representation of the identifying feature corresponding to the black elements are filled with material, and the regions corresponding to the white elements are empty.

10. The method of claim 8, wherein the regions of the three-dimensional representation of the identifying feature corresponding to the black elements are filled with a first material, and the regions corresponding to the white elements are filled with a second material.

11. A method of authenticating an additively manufactured part, comprising the steps of:
obtaining a series of internal images of an additively manufactured part;
selecting a subset of the series of internal images that constitute a region in which the identifying feature is embedded;
scaling and rectifying the subset of the series of internal images to form a two-dimensional representation of the identifying feature;
producing a processed image of the embedded identifying feature, by performing a set of image processing steps on the two-dimensional representation having a plurality of pixels at different greyscale intensities, comprising:
increasing the contrast of the two-dimensional representation;
calculating a threshold value based on the greyscale intensities;
assigning each pixel with a value above the threshold to be white; and
assigning each pixel with a value below the threshold to be black;
calculating a discrepancy between the thresholded two-dimensional representation of the identifying feature an original image of the identifying feature; and
if the discrepancy is less than a threshold value, authenticating the additively manufactured part.

12. The method of claim 11, wherein the identifying feature is a QR code having at least one position identifying feature.

13. The method of claim 12, wherein the set of image processing steps further comprises the steps of:
detecting contours within the two-dimensional representation;
determining position and orientation of the at least one position identifying features based on the contours;
generating a grid having a plurality of cells within the two-dimensional representation based on the position and orientation of the at least one position identifying features; and
assigning each grid cell a value of black or white based on the values of the pixels within the grid cell.

14. The method of claim 11, wherein the identifying feature is a linear barcode.

15. The method of claim 11, wherein the identifying feature is divided into a plurality of segments, each of the plurality of segments printed into a different layer of the additively manufactured part; and
wherein the method further comprises the step of combining a set of images taken at different layers of the additively manufactured part to form a single two-dimensional representation of the identifying feature.

16. The method of claim 11, wherein the series of internal images is obtained via at least one selected from the group consisting of a CT scan and an ultrasonic scan.

17. The method of claim 11, wherein the additively manufactured part is substantially transparent and the series of internal images are obtained via digital imaging.

18. The method of claim 11, wherein the contrast is increased using multiple iterations of a contrast limited adaptive histogram equalization (CLAHE) algorithm.

19. (canceled)

20. (canceled)

21. A product made from the process of claim 1, wherein the product is created by an additive manufacturing process, and contains a region beneath the surface of the part comprising a three-dimensional representation of an identifying feature.

22. The product of claim 21, wherein the identifying feature is a QR code.

23. The product of claim 21, wherein the three-dimensional representation of the identifying feature comprises a plurality of cavities.

24. A product printed using an additive manufacturing process, the product comprising a three-dimensional representation of a QR code positioned wholly within the product, beneath the surface of the product.

25. The product of claim 24, comprising at least one selected from the group consisting of ABS and titanium.

26. (canceled)
